(19) United States
(12) Patent Application Publication
(10) Pub. No.: US 2004/0141005 A1
(43) Pub. Date: Jul. 22, 2004

(54) System and method for integrating online meeting materials in a place

(75) Inventors: Mustansir Banatwala, Hudson, NH (US); Sergei R. Landar, Cambridge, MA (US); Charles R. Hill, Belmont, MA (US); Sami M. Shalabi, Arlington, MA (US)

Correspondence Address: Shelley M. Beckstrand, 314 Main Street, Owego, NY, 13827-1616, US

(73) Assignee: International Business Machines Corporation, Armonk, NY

(21) Appl. No.: 10/349,356

(22) Filed: Jan. 22, 2003

(51) Int. Cl. G09G 5/00

(52) U.S. Cl. 345/751

(57) ABSTRACT

A system is provided for integrating online meeting materials, including an asynchronous place server; a synchronous meeting server; a first user client; a meeting creation user interface presented at the first user client by the place server for receiving from the user meeting indicia including meeting information, meeting description, and meeting attachments; the asynchronous place server responsive to the user submitting the meeting indicia for storing the meeting description and the meeting attachments, and for forwarding to the meeting server the meeting information for creating the meeting; and during meeting viewing, the synchronous meeting server serving meeting information to a plurality of users viewing the meeting, and the asynchronous place server serving the meeting description and the meeting attachments to the plurality of users.

### CROSS REFERENCES TO RELATED APPLICATIONS

Copending U.S. patent application

Ser. No. 10/334,269 filed Dec. 31, 2002 entitled “SYSTEM AND METHOD FOR THE AGGREGATION OF PLACE INFORMATION IN A MULTI-SERVER SYSTEM”;

Ser. No. 10/334,261, filed Dec. 31, 2002 entitled “SYSTEM AND METHOD FOR AGGREGATING USER PROJECT INFORMATION IN A MULTI-SERVER SYSTEM”;

Ser. No. 10/334,296, filed Dec. 31, 2002, entitled “SYSTEM AND METHOD FOR CENTRAL REFRESH OF PLACE OBJECTS”, assignee docket LOT920020061US1;

Ser. No. 10/334,268, filed Dec. 31, 2002, entitled “SYSTEM AND METHOD FOR SEARCHING A PLURALITY OF DATABASES DISTRIBUTED ACROSS A MULTI SERVER DOMAIN”, assignee docket LOT920020064US1;

Ser. No. 09/752,120, filed 29 Dec. 2000, entitled “METHOD AND SYSTEM FOR CREATING A THEME OF A PLACE TO BE USED AS A TEMPLATE FOR OTHER PLACES”;

Assignee Docket LOT920020031US1, Ser. No. 10/______, entitled “SYSTEM AND METHOD FOR HIERARCHICALLY INVOKING RE-ENTRANT METHODS ON XML OBJECTS”;

Assignee Docket LOT920020032US1 Ser. No. 10/______, entitled “SYSTEM AND METHOD FOR COMMAND LINE ADMINISTRATION OF PROJECT SPACES USING XML OBJECTS”;

Assignee Docket LOT920020068US1 Ser. No. 10/______, entitled “SYSTEM AND METHOD FOR INTEGRATING PROJECTS EVENTS WITH PERSONAL CALENDAR AND SCHEDULING CLIENTS”;

are assigned to the same assignee hereof and contain subject matter related, in certain respect, to the subject matter of the present application. The above identified patent applications are incorporated herein by reference.

### BACKGROUND OF THE INVENTION

1. Technical Field of the Invention

This invention relates to online meetings. More particularly, it relates to integrating online meeting materials in a place, such that while the meeting itself is scheduled with a meeting provider, the meeting materials stay with the place.

2. Background Art

Typically, meeting providers provide their own repository for meeting materials. The user scheduling the meeting has to gather all the meeting related materials and submit them along with the meeting. Additional review or tracking of changes to the meeting materials is bound to the meeting service provider and reflects the life-cycle of the meeting.

Since the materials are tied to the meeting service provider, the context of the meeting materials is lost in the larger scope of the project. Keeping track of modifications becomes tedious. It is the meeting organizer's responsibility to synchronize the larger project with actions that occurred during the meeting on these meeting materials. Meeting materials cannot be modified using the meeting service provider once the meeting is over. Administration, such as backups and deletes to the meeting materials, is controlled by the meeting service provider and has no bearing on the project to which the meeting may have been related.

Typical mail systems support a scope of awareness that is “all registered users”-wide. In order to show presence awareness of a user A, user B first has to receive email from user A. There is in such systems no notion of community, which is project or place wide.

Heretofore, the IBM® Lotus® Quickplace® server enabled asynchronous collaboration in a Quickplace. A user was enabled to post docments, make responses, and so forth in the collaboration space provided. A user entering that space is provided with a multiplicity of names and posted documents, and may have been presented with the necessity of making email, personal or telephone contact with other members of the QuickPlace in order to obtain information or answers. There is a need, however, to provide a system and method for enabling synchronous collaboration.

The IBM® Lotus® SameTime® server supports synchronous communication, in the sense that a user is presented a user interface which enables the user to select a chat function.

There is a need in the art for a system and method which enables synchronous communication in a place managed by an asynchronous server.

Domino, IBM, the IBM Logo, Lotus, Notes, QuickPlace and SameTime are trademarks of International Business Machines in the United States, other countries, or both.

### OBJECTS AND SUMMARY OF THE INVENTION

It is an object of the invention to provide a system and method for integrating online materials.

A method is provided for integrating online meeting materials, including serving to a user client of an asynchronous place server, a user interface for creating a meeting; receiving at the user interface meeting information, meeting description, and meeting attachments; responsive to the user submitting the meeting, storing the meeting description and the meeting attachments at the asynchronous place server and forwarding the meeting information create the meeting at a synchronous meeting server; and serving to a plurality of users viewing the meeting meeting information from the synchronous meeting server and the meeting description and the meeting attachments from the asynchronous place server.

A system is provided for integrating online meeting materials, including an asynchronous place server; a synchronous meeting server; a first user client; a meeting creation user interface presented at the first user client by the place server for receiving from the user meeting indicia including meeting information, meeting description, and meeting attachments; the asynchronous place server responsive to the user submitting the meeting indicia for storing the meeting description and the meeting attachments, and for forwarding to the meeting server the meeting information for creating the meeting; and during meeting viewing, the synchronous meeting server serving meeting information to a plurality of users viewing the meeting, and the asynchronous place server serving the meeting description and the meeting attachments to the plurality of users.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a high level system diagram illustrating a typical system configuration in accordance with the preferred embodiment of the invention.

FIG. 2 is a system diagram illustrating an exemplary multi-server environment.

FIG. 3 is a diagrammatic representation of the object model of a QuickPlace.

FIG. 4 is a high level system diagram illustrating the integration of project events with personal calendar and scheduling clients.

FIG. 5 is a system diagram illustrating dynamic and offline methods for aggregating information about servers and places in a multi-server environment which may include clusters.

FIG. 6 is a high level system diagram illustrating the preferred embodiment of the invention for user scheduling of on-line meetings from within a place and attaching materials to the meeting document created by the place server.

FIG. 7 is a diagrammatic representation of a process for creating a meeting.

FIG. 8 is a diagrammatic representation of a plurality of users attending, or viewing, a meeting on clustered servers.

FIG. 9 is a diagrammatic representation of a meeting form in edit mode.

FIG. 10 is a diagrammatic representation of a meeting form in read mode.

FIG. 11 is a diagrammatic representation of a SameTime meeting center page.

### BEST MODE FOR CARRYING OUT THE INVENTION

In accordance with the preferred embodiments of the invention, a system and method is provided for integrating online meeting materials in a place. The meeting itself is scheduled with the meeting provider, but the meeting materials stay with the place.

Meeting materials can be modified with updates and additional meeting materials at any time, including during and after the meeting. These modifications stay in the place meeting document and, therefore, context and changes are available in the place itself at any time to authorized users. Consequently, the life-cycle of meeting materials is determined by the life-cycle of its corresponding place.

By tracking all team members online status and displaying the same in a number of places throughout the workspace, additional commands can be easily invoked off the name so that instant-messaging, instant online-meetings can take place very easily.

By enabling users to schedule meetings from within the workspace and putting the meeting information on the calendar in the team space, thus letting users of QuickPlace (workspace) easily get a list of all scheduled meetings, a calendar invitation may be distributed to team users in reference to the meeting so that the invitation can be scheduled on the user's calendar of choice.

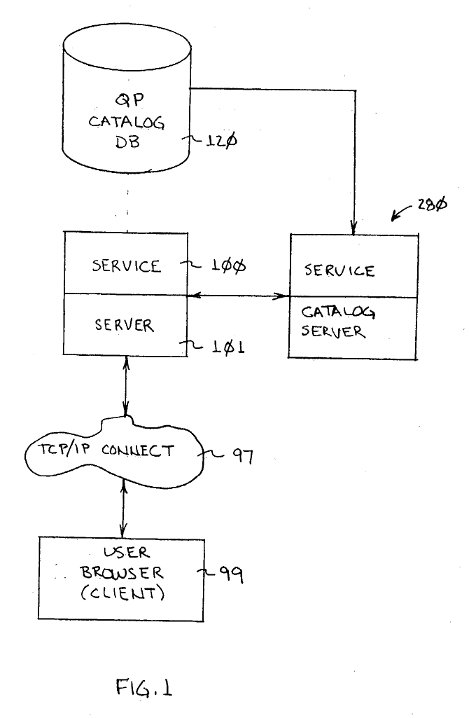

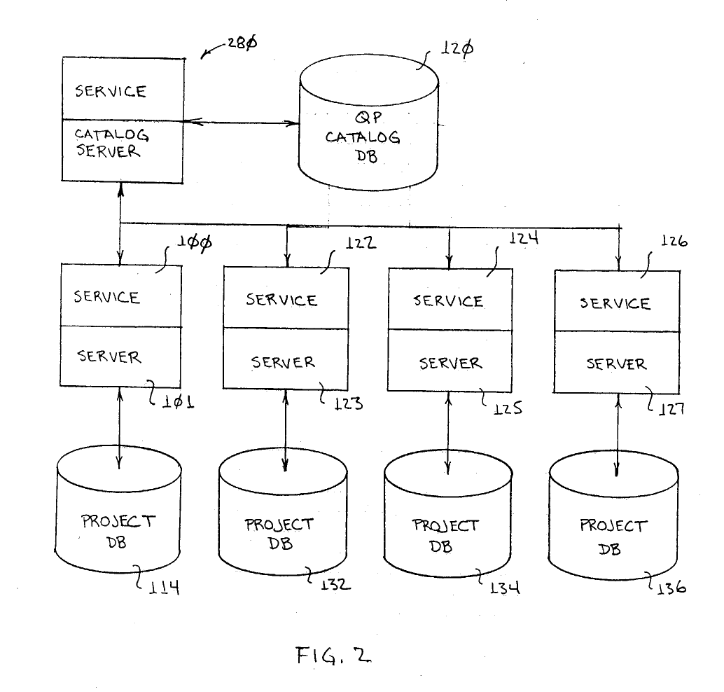

Referring to FIGS. 1 and 2, a system environment of interest includes QuickPlaces 114, 132, 134, 136, in a multi-server system environment, including service 100/server 101, 122/123, 124/125, and 126/127, communications link 97, one or more client terminals, such as user browsers 99, and a database including, for example, a catalog 120, such as a QuickPlace catalog, for aggregating information about projects.

Throughout this specification, the generic term “project” and more specific terms “place” or “QuickPlace” are used substantially interchangeably. Place and QuickPlace are specific examples of projects. Similarly, “host catalog” and “QuickPlace catalog” are equivalent terms.

The functionality available to each user via remote terminals 99 may be customized in accordance with the needs and authorization of the user and/or entity. Terminals 99 may access the system using, for example, browser software technology or other electronic accessing methods as my be known to one of skill in the art. Reports and other information displayed to the end user at terminal 99 may be displayed using known web page formatting techniques.

Communication link 97 links remote terminals 99 to server 101. Link 97 may be a hardwired link, such as a telephone line, coaxial cable, digital data line, or the like, or a wireless link such as a radio frequency or infrared communications link, or the like.

As illustrated in FIG. 1, a QuickPlace service 100 represents a group a servers that are able to communicate with each other through a network, and work together to provide function (such as project creation, search across projects and servers, and get aggregate view across all servers and projects).

This service may be implemented in an abstract sense, in that each server 100 implements a notion of service, which in this sense is a multi-server deployment of QuickPlace servers 101 that can be treated as a consistent unit of service for administration and in the user interface.

A QuickPlace service 100 comprises multiple QuickPlace servers 101 and/or QuickPlace clusters, which: (1) are in the same IBM® Lotus® Domino™ domain; (2) share the same user directory and authentication system; (3) are on the same user network (i.e., are not separated by a firewall); and (4) are administered by the same administration team. These constraints are enough to ensure across the service that: (1) servers 101 can be configured consistently; (2) servers 101 can communicate and share data with each other; (3) user identities are in the same name space and do not collide; and (4) single sign on authentication can be implemented.

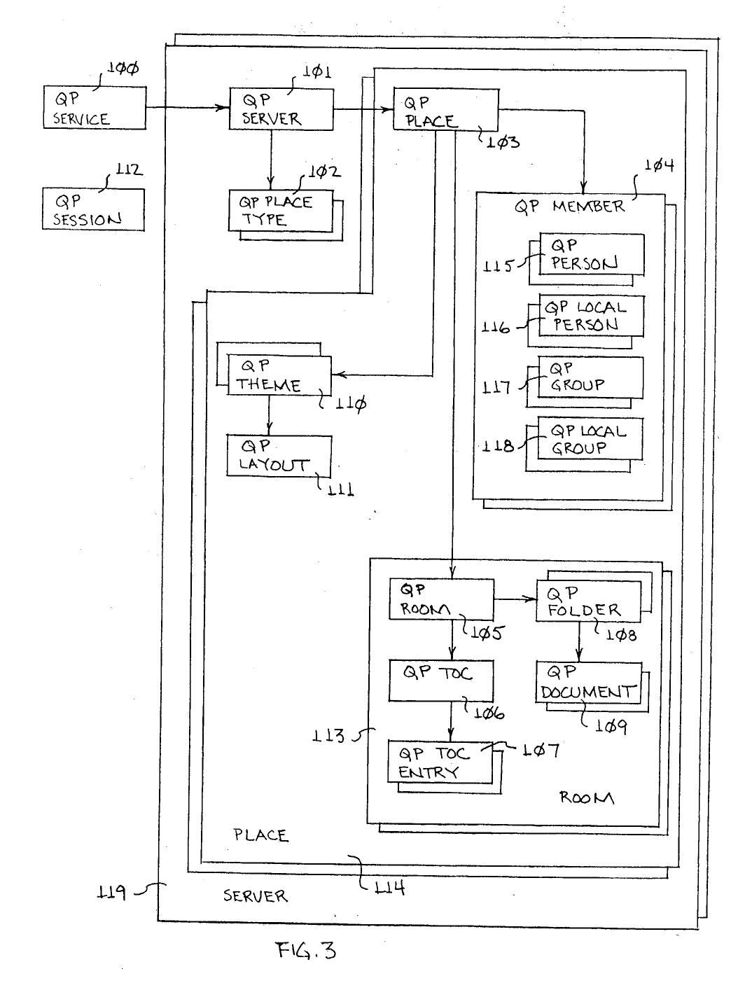

Referring to FIG. 3, an object model representation of a QuickPlace is presented. Each box represents a unit that can be manipulated and used to retrieve and store data. Each object has several associated methods.

QP service 100 represents the service. A service is an object that signifies a group of servers in an organization. There is one instance of a service 100 for any group of servers. Thus, a QuickPlace service is a multi-server deployment of QuickPlace servers that can be treated as a consistent unit of service for administration and in the user interface.

A QuickPlace service comprises multiple QuickPlace servers and/or QuickPlace clusters, which: (1) are in the same Domino domain; (2) share the same user directory and authentication system; (3) are on the same user network (i.e., are not separated by a firewall); and (4) are administered by the same administration team.

These constraints are enough to ensure across the service that: (1) servers can be configured consistently; (2) servers can communicate and share data with each other; (3) user identities are in the same name space and do not collide; and (4) single sign on authentication can be implemented.

A QuickPlace cluster is treated as a single virtual server in the service model.

Server 101 represents a physical or virtual server entity that is addressable and may contain a group of places and place types.

Place 103 is an object that represents a place or project. This is the entry point into a particular project and all its data and all its manipulations—including logical methods such as lock, remove, member, and so forth.

QP members 104 represents members of place 114. There are many kinds of members, including person 115, local person 116, group 117 and local group 118. Members 104 are the seed of any membership operation done in the place 103. Each member has an associated identity and profile.

Room 105 represents a room 113 within a project 114.

In an exemplary embodiment, a project is a place, which is content and membership associated with that content.

A room 105 controls access to a subset of the data in the project 114, including table of contents (TOC) 106, and folders 108.

TOC 106 represents the table of contents of a room 113, which is composed of many TOC entries 107, which TOC entry includes a url to a content and the associated type (folder, room, document, etc.) of that content.

Folder 108 contains many documents 109, and each room 113 can contain many folders 108.

Documents 109 represent documents in a place 114.

Each place 114 may contain many themes 110. A theme is an object that represents how to lay out the user interface for this project, and how to brand the user interface.

Layout 111 specifies one of the ways a theme 110 is laid out. Associated with each theme 110 there may be several layouts.

Session 112 is a session needed to work with this object model. It provides for associating an identity with any manipulation. For example, if when creating a place 114 on a server 119, session 112 represents the identity of the individual. If that individual does not have authorization to create a place 114, an error will be received.

Rooms 113 represent multiple rooms in a place 114.

Places 114 represents multiple places on a server 119.

Each object is able to represent itself as xml and recreate itself from exported xml.

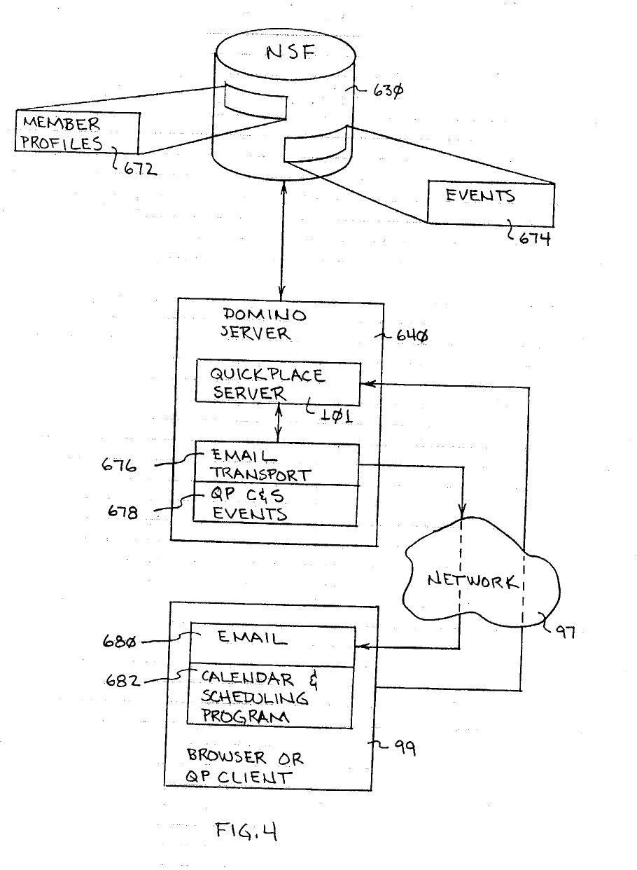

Referring to FIG. 4, a preferred embodiment of the client/server system of the invention includes on the system side a Domino Server 640 and a place database 630, which includes a member profiles database 672 and an events database 674. Server 640 includes a Quickplace server 101 and an email transport facility 676 which includes a quickplace calendar and scheduling events store. On the client side, browser or quickplace client 99 includes an email application and a calendar and scheduling program.

In operation, a user at client 99 can specify that an event that is saved in this quickplace 101, for example, is to be sent to users who have set their member profile to receive calendar events from this quickplace 101 in their calendar and scheduling client.

User actions which will cause other users to receive an event notification are create, update, and delete events at the server 640. The event 674 to be calendared is created in the place itself. The user of the place subscribes in profile 672 to the calendar, and specifies the type of calendar he uses. The event 678 sent from server 101 by email transport 676 can then be personalized to the user selected C&S application 682 as an attachment to email 680, such as in Notes format or icalendar format.

When an event 678 is created in server 640, it checks the member profile 672 to see who has subscribed to receive calendar event 674. For each member who has subscribed, it checks for calendar program type, and then generates the appropriate format e-mail for distribution to each set of users (a set each for those who have requested Notes 5, Notes 6 or iCalendar format).

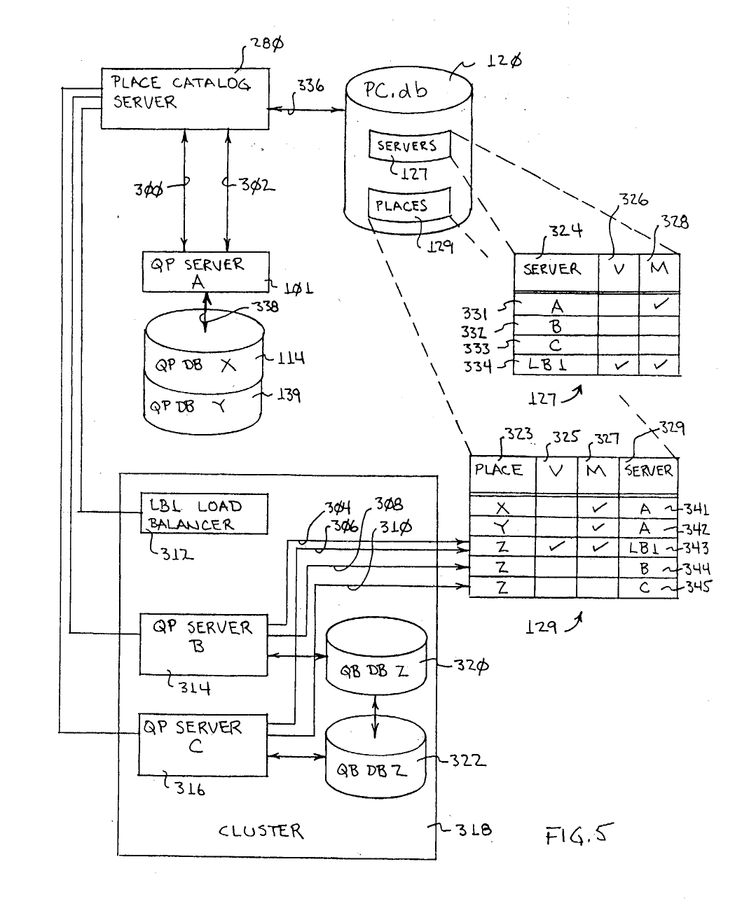

Referring to FIG. 5, host catalog server 280 is a Domino server with QuickPlace installed which has been configured as is represented by line 336 to host catalog database 120 and which is accessible as is represented by lines 300, 302 to QuickPlace servers 101 in the enterprise through the IBM® Lotus® Notes® RPC (tcp port 1352) and http protocols. A typical project, or QuickPlace, cluster 318 includes a load balancer (LB) LB1 server 312, a plurality of other servers 314, 136, and respective project databases 312, 322. A project cluster 318 is treated as a single virtual server in the service model.

Some entries 331-334, 341-345 are created or updated in the Host catalog 120 in real time—substantially the moment an event happens. Other entries are created or updated manually by a server task, or on a scheduled basis.

As is represented by line 300, it is essential that certain data be sent in real time to avoid conflicts. For example, in a QuickPlace service 100 there cannot be two places 114, 139 with the same name. The creation of a new place 139 is an event that creates a new entry in Catalog 120 in real time. When a user creates a new place, QuickPlace server 101 first checks catalog 120 database 129 for that name 323 before creating a new entry. If it finds an existing place with that name, the user is prompted to choose a different name. If the creation of a place 139 did not immediately create an entry, it would be possible for two users to successfully create two places with the same name, which would cause a conflict when QuickPlace attempted to create entries for both in the catalog 120. To increase availability of host catalog 120, the Domino clustering feature can be used to make several host catalog servers 280 available.

Data can be updated in catalog 120 using a QPTool placecatalog-push command or on a schedule on the QuickPlace server 101.

Host catalog 120 contains information in servers view 127 about servers and in places view 129 about places. Thus, in host catalog 120, there is an entry 331 for server A 101. For simple case aggregation, or data update, projects 114, 139 are preconfigured as is represented by line 300 to point to host catalog server 280 immediately when changes occur, or as is represented by line 302 at a particular time (say, each day at 2:00 a.m.) Immediate changes may thus be made when change actions occur such as place create, place remove, place lock, change access (add/remove readers, authors, managers), and change title. Scheduled updates may be made, for example, for changes such as last modified, title, size, last accessed.

Complex aggregation is required when working with clusters 318.

Each entry in catalog 120 has a virtual indicia entry 325, 326 and master indicia entry 328, 327. A master entry, such as entry 343, is the entry through which all access to the catalog occur for a given cluster of servers 312, 314, 316. In FIG. 5, servers A 101 and LB1 312 are master servers, and columns 327 and 328 are set for corresponding entries 331, 334, and 341-343.

A virtual server is a server that does not have project (aka, place) data, but knows how to connect place users to the project servers 314, 316 which do have place data 320, 322. Server LB1 312 is a virtual server because it does not have place data in a database. Project servers A 101, B 314, and C 316 are not virtual servers because they do have place data in databases X 114, Y 139, and Z 320, 322. Databases Z 320, 322 are clustered, so they are identical; a change to one is immediately replicated to the other.

Complex aggregation for clusters is done by sending immediate updates as are represented by lines 304 and 306 to master entries 334, 343. All other updates as are represented by lines 308 and 310 to the corresponding place entry 344, 345 for the respective servers B 314, C 316. For scheduled update, host catalog server 280 executes a process to merge entries from the virtual master LB1 312 (see entry 343, which as virtual field 235 and master field 327 set) to merge entries from the virtual master entry 343 to entries 344, 345 for other servers B 314, C 316.

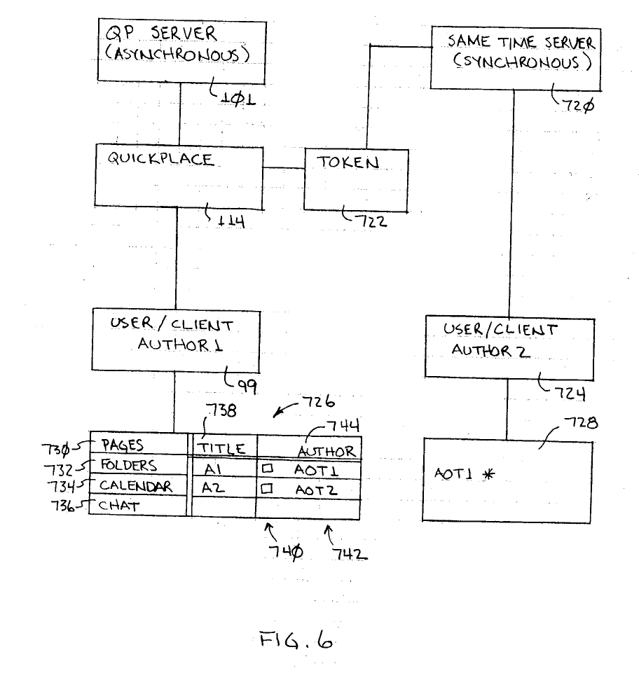

Referring to FIG. 6, a system in accordance with the preferred embodiment of the invention includes a QuickPlace server 101, a QuickPlace 114, a Sametime server (or Sametime server cluster) 720, a terminal 99 for a first author or user AOT1, and a terminal 724 for a second author or user AOT2. Token 722 is a plug for attaching QuickPlace 114 to a synchronous service 720. Panel 726 represents a user interface (UI) presentation at client terminal 99 and panel 728 a UI presentation at client terminal 724. Server 720 may be any synchronous meeting server, such as Sametime, AOL, MSM messenger, or Yahoo servers.

The QuickPlace asynchronous service provider 101 and the Sametime synchronous service provider 720 are configured to use Multi-server session authentication (MSSO), which means that a user who is logged into one server 101, 720 can log-in and use services of the other server 720, 101 without having to provide authentication credentials again. For example, a user logs into to QuickPlace 114 on QuickPlace server 101 and after authentication receives a token (actually, browser 99 receives a cookie). That cookie is then passed to all participating servers 720, 123, 125, 127 in the domain. The cookie helps identify who the person is and guarantees authenticity of that person, in the sense that a trust is established between the participating servers that the server 101 that issued the token 722 has properly authenticated this person and the contents of the token can be trusted. This token 722 is passed from QuickPlace 114 to Sametime server 720 to avoid re-, authentication issues (such as a challenge box being shown to the user). Sametime server 720 extracts the current user name from token 722 and, depending on the users authorization, provide the requested services, including awareness and meeting creation services, as will be described hereafter.

User interface 726 includes, for example, pages 730, folders 732, calendar 734 and chat 736 selector buttons, and a display of meetings 726 showing title of meeting 738, and author 744, including name 742 and Sametime link icon 740.

User 724 is logged in to synchronous Sametime server 720 and user 99 is logged in to asynchronous QuickPlace server 101. In order to bring a synchronous level of awareness into QuickPlace 114, Sametime 720 services are merged into QuickPlace by way of Sametime link icons. Thus, where ever a user name is displayed, code is provided for accessing SameTime server 720 to determine if this user is actually logged into SameTime. If user 99 is not on-line, upon logging in to QuickPlace 114, user 99 is logged into Server 720, making user 99 online for all other users 724 currently on-line. In this case, the name AOT1 for user at client 99 is highlighted or otherwise marked, such as by “*”, in displays 728 for users 724 where ever his name AOT1 appears. With user 724 logged in to service 720, his name AOT2 is presented in UI 726 with a Sametime link icon 740 which, for example, displays green when on-line, grey when off-line, and 0 for “do not disturb”.

When user 99 enters QuickPlace 99, his user interface 726 displays all author names 742 and their on-line status 740, including whether they are in place 114 or logged on to some other on-line server 720. In the example of FIG. 6, author AOT1 is a user 99 logged into QuickPlace 114, author AOT2 is a user logged into SameTime server 720, and both register in their respective UIs 726, 728 as on line.

When a user clicks, for example, on a name 742, a menu is presented giving as choices chat, instant meeting with this person, membership, telephone number, and email address. Chat presents a dialog box with text only messaging. Instant meeting presents a client with a chat component but also an on-line awareness component, and an application whiteboard. Membership information presented at UI 726 gives, for the selected user, the member profile as defined in QuickPlace 114. Telephone number and email address provide links which may be selected by user 99 to send a message to or connect to the other user 724.

A user 99 may schedule a meeting through QuickPlace 114 which accesses SameTime server 720 via a remote API to define when, name, duration and password for the meeting, along with attachments. This meeting shows up on the QuickPlace calendar. When the meeting is posted to SameTime server 720, a link to that meeting on SameTime is provided in the QuickPlace calendar, which link provides the url to the meeting at SameTime 720.

Communication between SameTime server 720 and QuickPlace server 101 requires authentication of users logging in. Domino single signon results in tokens being passed from QuickPlace server 101 to SameTime server 720 when user 99 logs on to QuickPlace server 101 advising SameTime server 720 that user 99 is a valid, trusted user.

Selection of chat 736 presents the names of users currently on-line to QuickPlace 114.

Selection of calendar 734 presents at UI 726 a list of meetings to which the user has been invited and has marked in a global calendar, a calendar which is presented to user irrespective of which QuickPlace 114 he logs on to. This provides community awareness. That is, no matter if a first place 114 member posts any documents or not, his name will appear in people-online window 726, 728 of all members of place 114 with links enabled to Sametime 720, without any initiation steps required. At the same time, the concept of community does not limit the scope of awareness to a particular place 114. A second user 99 can still receive instant messages and meeting invitations from a user 724 who is not a member of place 114 but uses the same Sametime server or servers cluster 720.

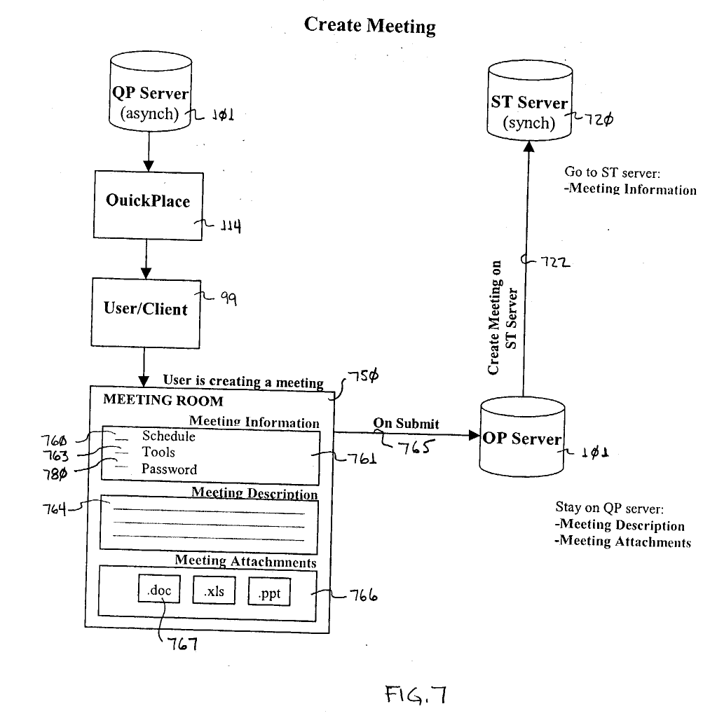

Referring to FIG. 7, for meeting creation, a user 99 logged on QuickPlace 114 and QP server 101 enters at user interface 750 meeting information 761, including schedule 760, tools 763, and password 780; meeting description 764; and attachments 766. On submit 765, as is represented by line 722, server 101 creates a meeting by passing meeting informaiton 761 to SameTime server 720 and stores meeting description 764 and meeting attachments 766, including documents 767, at server 101.

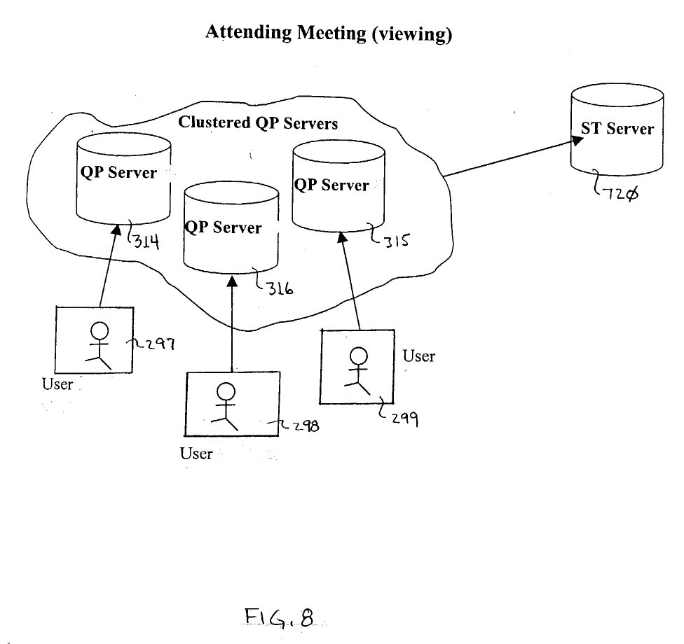

Referring to FIG. 8, users 297, 298, and 299 are shown attending a meeting on SameTime server 720. Viewing any of the attached meeting materials, including meeting description 764 and meeting attachments 766 is deferred to the QuickPlace server the user is connected to, and distributed in the case of a clustered environment as if user 297 is using server 314, user 298 is using server 316, and user 299 is using server 315. In the case where user 297 is a meeting moderator, to make changes to the meeting materials as a group, user 297 brings up the meeting page 750, double-clicks on the attachment 766 and shares the resultant application. The same also applies to new documents 767 created in the meeting page.

### Scheduled Meetings

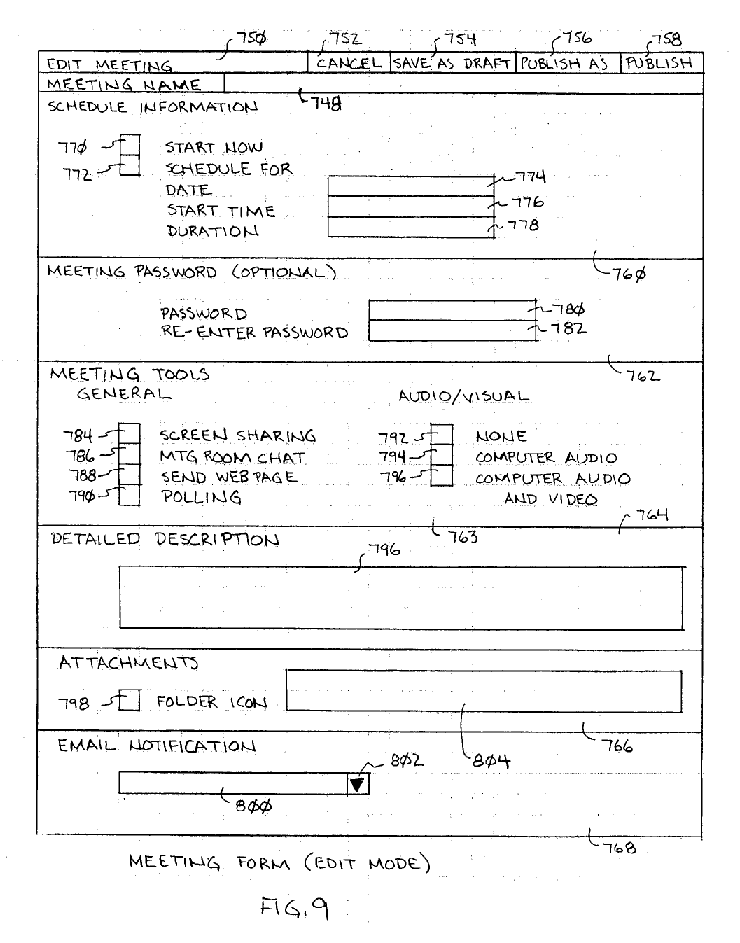

Referring to FIG. 9, a meeting form in edit mode 750 is illustrated which is presented at UI 726 to a user 99, such as a manager or author with appropriate authority, in response to the user selecting from a home page (not shown) a new form and selecting “meeting” from a list of available forms. Meeting form 750 includes cancel button 752, save as draft 754, publish as 756, and publish 758 selector buttons, a meeting name input field 748, and schedule information panel 760, meeting password panel 762, meeting tools panel 763, detailed description panel 764, attachments panel 766 and email notification panel 768.

Schedule information panel 760 provides user selection buttons 770 for starting a meeting, and 772 for scheduling a meeting. Input panels 774 are provided for the user enter a start date, 776 for entering a start time, and 778 for entering the meeting duration.

Panel 762 allows the user to protect the meeting by optionally giving it a password 780, which is reentered at input panel 782 for verification.

Meeting tools 763 includes general meeting tools screen sharing 784, meeting room chat 786, send web page 788, and polling 790; and audio/visual tools none 792, computer audio 794, and computer audio and video 796.

Detailed description panel 764 includes an entry area 796 the user provide a description of the meeting being scheduled.

Attachments panel 766 provides for selection of attachments to be associated with the meeting. A folder icon 798 may be selected, which will bring up in window 804 a display of user files for selection, or files may be dragged into area 804 from the user's desktop.

Email notification panel 768 provides a drop down 802 listing 800 of members to be notified when this page is published.

When the user has finished editing this page, he clicks publish 758 to put it away so others can see it, publish as 756 for more options. To safeguard his work in progress while editing the page, he clicks save as draft 754.

When the user clicks publish 758, publish as 756, or save as draft 754, the meeting is scheduled at the SameTime server 720. If the meeting cannot be scheduled, an error dialog is displayed. Otherwise the meeting is published on the room 114 calendar. (Using Publish As 756, the meeting can also be saved to a folder for categorization.)

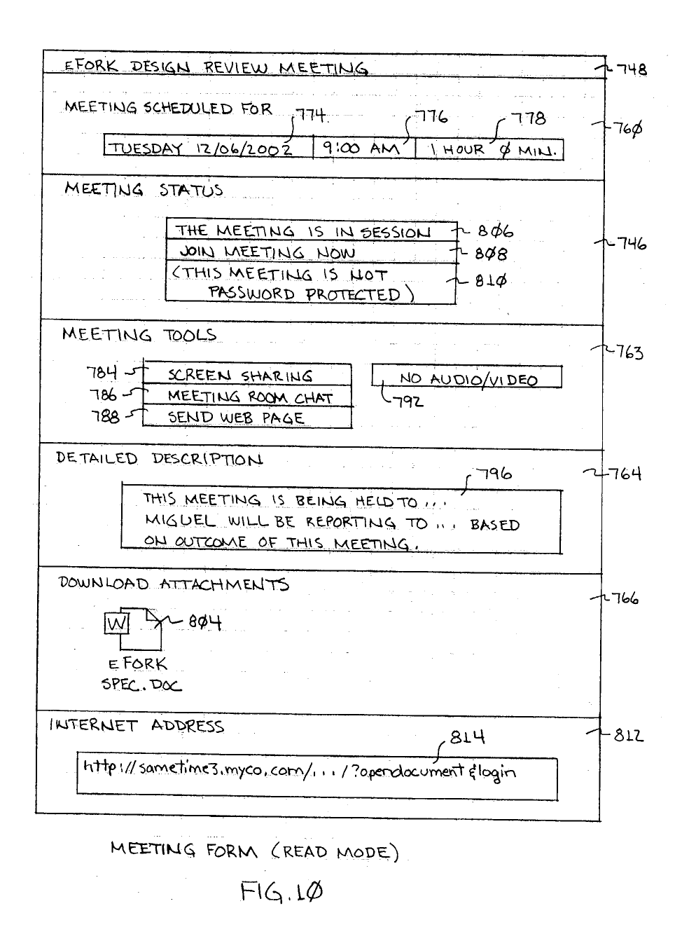

Referring to FIG. 10, meeting form in read mode includes meeting title 748, schedule display 760 including day 774, time 776 and duration 778 displays, meeting status panel 746, meeting tools panel 763, detailed description panel 764, download attachments panel 766, and Internet address panel 812 which displays in window 814 the URL of the meeting.

Meeting status 746 includes meeting in session display 806, join meeting 808, and a display 810 indicating whether or not the meeting is password protected. Meeting tools 763 displays those meeting tools selected from meeting tools panel 763 in edit mode. Detailed description 796 displays the description entered during meeting set up (FIG. 9). In panel 766, the user can drag attachments 804 to the desk top and double click to open them.

QuickPlace 114 members can go to the meeting by visiting the page 820 in QuickPlace 114, which displays a meeting status 746. When the meeting is in session, a button 806 is displayed that enables the user to open the meeting directly into the SameTime meeting room Client (without viewing the meeting page in the meeting center).

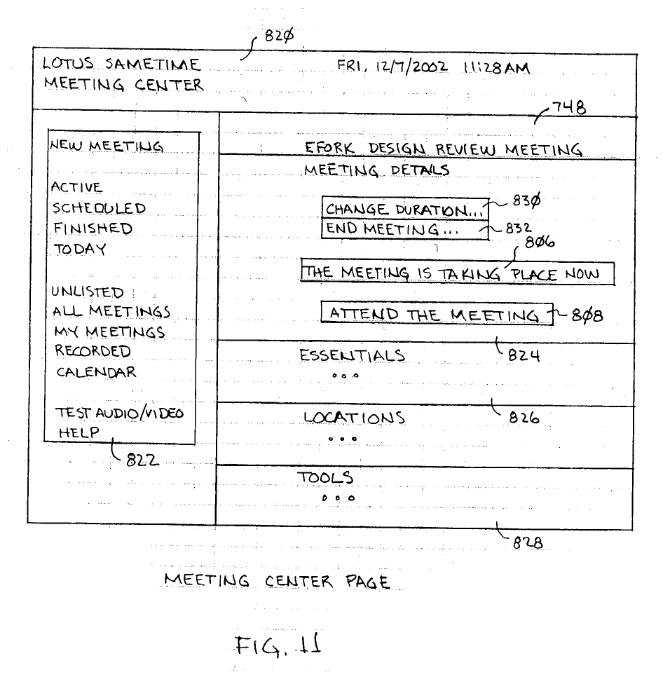

All invitees (including people who are not members of the QuickPlace 114) can go to the meeting by going directly to its URL 814. Referring to FIG. 11, in this case, the meeting center page 820 is displayed, and the meeting can be joined from this point by selecting attend the meeting 808. Meeting center page 820 includes a table of contents (TOC) 822 to available functions, meeting title 748, meeting details 824 including change duration interface 830, end meeting interface 832, and indication 806 that the meeting is taking place if it is, and several other panels 826-828 with further information.

If QuickPlace server 101 is not configured to connect to at least one Sametime meeting server 720, all meetings user interfaces 750, 748, 820 are hidden in the QuickPlace client 99.

Referring to Table 1, the mapping between Sametime meeting parameters, as exposed in the meeting center new meeting UI of FIG. 11, is set forth.

TABLE 1
SAMETIME/MEETING CENTER UI PARAMETERS MAPPING

| | Settings Exposed on | Automatically Configured |
|---|---|---|
| UI Area | the Meeting Form | Settings |
| Essentials | Meeting name = | Meeting type = |
| | QP page title | collaboration |
| | Schedule (date, | Moderator = QP page |
| | time, duration) | author |
| Files | Detailed meeting | |
| | description | |
| Security | Meeting password/ | Restricted meeting to |
| | re-type password | specified people = NON |
| | | Secure this meeting by |
| | | not listing in the |
| | | meeting center = TRUE |
| | | Secure this meeting by |
| | | using encryption = TRUE |
| | | (by default, or other- |
| | | wise set by a QP server |
| | | setting). |
| Tools | All MRC options | Meeting client = Use |
| | except for | meeting room client |
| | whiteboard | |
| Locations | | People are attending |
| | | using a modem = TRUE |

Status message 806 says either:

“The meeting has not started.”

“The meeting in session.”+button 808 labeled “Join

Meeting Now”

“The meeting is finished.”

Meetings displayed on the QuickPlace 114 calendar, alongside other calendar events.

Meetings can be saved to a folder, as well as the calendar, via Publish As 756.

To control access to meeting creation, a Change Basics “Meeting options” is provided with two radio buttons: (1) Allow authors and managers to create meetings [selected by default], and (2) Only allow managers to create meetings.

Page access control is provided. By default, all readers and above (including anonymous users if enabled) are able to view the meeting page, and join meetings which are not password-protected.

Access to a Sametime meeting is controlled by (a) not listing the meeting in the Sametime Meeting Center and (b) the optional meeting password.

Replication within a cluster works by default. Each replica of a meeting page points to the same meeting on the Sametime server.

By way of example, a Quality Task Force may be assembled to address quality problems in the MyCo, Inc., product line. The task force is represented by all functions of the company at several sites in North America. The manager of the task force, creates a QuickPlace named “Quality2002” to hold task force documents and discussions, and adds her colleagues as authors. One of the manager's first actions is to schedule a repeating online meeting which will be held from 1 PM-2 PM every Thursday. Using QuickPlace 114, she creates a new meeting, sets it to repeat as needed, chooses to include the “chat” 786 and “screen sharing” 784 tools, and enters a brief description 796 of the meeting and phone conference details into respective fields on the form 750. She chooses not to use a password 780 for the meeting, reasoning that only people from her task force will know about the meeting via the QuickPlace 114. She checks the option 800 to send a meeting notice to each member's personal calendar, and publishes 758 the meeting to the QuickPlace 114 calendar. Each member of the task force receives a IBM® Lotus® Notes® meeting notice, with a link labeled “Join the meeting” and a second link labeled “Go to the QuickPlace: ‘Quality2002’”. Each Wednesday, Mary sends a meeting reminder to the team if the meeting is on, or sends an email canceling it. Just before 1 PM each Thursday, Mary goes to the calendar to set up the meeting. Typically Mary shares her full screen so she can quickly switch between different documents 804 during the presentation, launching the documents directly from the QuickPlace 114. Team members publish to the QuickPlace any documents 804 that are needed in the weekly meetings. Other members join the meetings directly via the URL included in the calendar notification, or go to today's page in the calendar and join the meeting from its page in the QuickPlace. Frequently, Mary hands off segments of the meeting to other team members to present subcommittee reports, etc. Sometimes task force members invite non-member to attend or present in the weekly meetings by forwarding to them the meeting notice.

This is an intra-team meeting. The QuickPlace manager creates the meeting as a page in the QuickPlace 114, and the QuickPlace's calendar integration features in QuickPlace are used to notify users of the meeting status. The QuickPlace 114 is used to hold all meeting materials. Screen sharing allows the meeting moderator to browse the QuickPlace 114 and launch applications as needed. Meetings themselves are Sametime meetings, with the first priority screen sharing 784 and chat 736. This scenario assumes only basic security—the meeting will not be listed in the Sametime Meeting Center, and is therefore only known to the recipients of the calendar notifications. (The use of password protection would be indicated were SameTime server 720 outside of the firewall protecting QuickPlace 114.)

The system of the preferred embodiment of the invention, as heretofore described, provides for scheduling meetings in QuickPlace 114 on a remote SameTime server 720, editing and rescheduling a meeting by editing the meeting page in QuickPlace 114, deleting a meeting in QuickPlace 114, allowing for any invitees to join a meeting, not just QuickPlace members (i.e., separate security model from QuickPlace), displaying meeting URL 814 to QuickPlace users (e.g., on meeting form/in page abstract) to enable copy and paste into email messages, etc., hiding the entire meeting UI from a QuickPlace/PlaceType—e.g., via Customize-Forms-Show/Hide, limiting meeting creation to managers only, creating custom meeting forms—e.g., e-learning meeting with extra options such as support for the whiteboard.

### Awareness and Chat

Awareness features supported by QuickPlace 114 give users real-time awareness of other team members, online availability, enabling users to exchange instant messages as a natural extension of the QuickPlace 114 workspace.

A Chat window opened in response to selection of chat 736 lists all members of Place 114 who are currently online (in QuickPlace 114 or elsewhere). A signed in user is always online in Sametime community, and the online state is kept alive as user navigates from page to page within place 114.

### Alternative Embodiments

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as IBM Systems designated as zSeries, iSeries, xSeries, and pSeries, or the like and pursuant to one or more, or a part of one or more, program elements, modules or objects generated from any programming language, such as C++, Java, Pl/1, Fortran or the like. And still further, each said step, or a file or object or the like implementing each said step, may be executed by special purpose hardware or a circuit module designed for that purpose.

Accordingly, the scope of protection of this invention is limited only by the following claims and their equivalents.

We claim:

1. A method for integrating online meeting materials, comprising:
serving to a user client of an asynchronous place server, a user interface for creating a meeting;
receiving at said user interface meeting information, meeting description, and meeting attachments;
responsive to said user submitting said meeting, storing said meeting description and said meeting attachments at said asynchronous place server and forwarding said meeting information create said meeting at a synchronous meeting server; and
serving to a plurality of users viewing said meeting meeting information from said synchronous meeting server and said meeting description and said meeting attachments from said asynchronous place server.

2. The method of claim 1, further comprising operating said place server responsive to request from an authorized user to server meeting context and changes to meeting descriptions and meeting attachments to authorized users of said place.

3. The method of claim 1, said meeting information including schedule, tools and password indicia.

4. The method of claim 3, said meeting attachments selectively including links to documents, presentations, and style sheets.

5. The method of claim 4, said documents selectively including extensible markup language trees.

6. The method of claim 2, further comprising:
storing in a global calendar meetings marked by a user;
logging a user in to a second asynchronous place server; and
serving to said user a user interface presenting meetings to which said user has been invited and marked in said global calendar.

7. The method of claim 6, further comprising:
logging a plurality of users in to a respective plurality of asynchronous place servers in a cluster;
operating said synchronous meeting server to present said meeting information to said plurality of users viewing a meeting; and
deferring to each said place server in said cluster said meeting description and said meeting attachments for serving to said plurality of users.

8. The method of claim 7, further comprising:
responsive to a moderator among said plurality of users bringing up at its user interface in a meeting page a further attachment, serving a resultant application to said plurality of users.

9. The method of claim 8, further comprising:
sharing among said plurality of users new documents created in said meeting page.

10. A system for integrating online meeting materials, comprising:
means for serving to a user client of an asynchronous place server, a user interface for creating a meeting;
means for receiving at said user interface meeting information, meeting description, and meeting attachments;
means responsive to said user submitting said meeting, for storing said meeting description and said meeting attachments at said asynchronous place server and forwarding said meeting information create said meeting at a synchronous meeting server; and
means for serving to a plurality of users viewing said meeting, meeting information from said synchronous meeting server, and said meeting description and said meeting attachments from said asynchronous place server.

11. A system for integrating online meeting materials, comprising:
an asynchronous place server;
a synchronous meeting server;
a first user client;
a meeting creation user interface presented at said first user client by said place server for receiving from said user meeting indicia including meeting information, meeting description, and meeting attachments;
said asynchronous place server responsive to said user submitting said meeting indicia for storing said meeting description and said meeting attachments, and forwarding to said meeting server said meeting information for creating said meeting; and
during meeting viewing, said synchronous meeting server serving meeting information to a plurality of users viewing said meeting, and said asynchronous place server serving said meeting description and said meeting attachments to said plurality of users.

12. The system of claim 11, further comprising:
a cluster including a plurality of asynchronous place servers;
a plurality of user clients, each said user client logged in to one of said plurality of place servers for viewing a meeting;
said synchronous meeting server presenting said meeting information to said plurality of user clients; and
said place servers in said cluster serving said meeting description and said meeting attachments among said plurality of users.

13. A program storage device readable by a machine, tangibly embodying a program of instructions executable by a machine to perform method steps for integrating online meeting materials, said method comprising:
serving to a user client of an asynchronous place server, a user interface for creating a meeting;
receiving at said user interface meeting information, meeting description, and meeting attachments;
responsive to said user submitting said meeting, storing said meeting description and said meeting attachments at said asynchronous place server and forwarding said meeting information create said meeting at a synchronous meeting server; and
serving to a plurality of users viewing said meeting meeting information from said synchronous meeting server and said meeting description and said meeting attachments from said asynchronous place server.

14. The program storage device of claim 13, said method further comprising operating said place server responsive to request from an authorized user to server meeting context and changes to meeting descriptions and meeting attachments to authorized users of said place.

15. The program storage device of claim 13, said meeting information including schedule, tools and password indicia.

16. The program storage device of claim 15, said meeting attachments selectively including links to documents, presentations, and style sheets.

17. The program storage device of claim 16, said documents selectively including extensible markup language trees.

18. The method of claim 14, said method further comprising:
storing in a global calendar meetings marked by a user;
logging a user in to a second asynchronous place server; and
serving to said user a user interface presenting meetings to which said user has been invited and marked in said global calendar.

19. The program storage device of claim 18, said method further comprising:
logging a plurality of users in to a respective plurality of asynchronous place servers in a cluster;
operating said synchronous meeting server to present said meeting information to said plurality of users viewing a meeting; and
deferring to each said place server in said cluster said meeting description and said meeting attachments for serving to said plurality of users.

20. A computer program product for integrating online meeting materials according to the method comprising:
serving to a user client of an asynchronous place server, a user interface for creating a meeting;
receiving at said user interface meeting information, meeting description, and meeting attachments;
responsive to said user submitting said meeting, storing said meeting description and said meeting attachments at said asynchronous place server and forwarding said meeting information create said meeting at a synchronous meeting server; and
serving to a plurality of users viewing said meeting meeting information from said synchronous meeting server and said meeting description and said meeting attachments from said asynchronous place server.
